(19) United States
(12) Patent Application Publication
(10) Pub. No.: US 2018/0241018 A1
(43) Pub. Date: Aug. 23, 2018

(54) CYLINDRICAL BATTERY PACK AND POWER TOOL SYSTEM

(71) Applicant: BLACK & DECKER, INC., New Britain, CT (US)

(72) Inventors: Sean BAILEY, Towson, MD (US); Timothy W. FRENCH, JR., Hampstead, MD (US); Tyler M. KNIGHT, Ellicott City, MD (US); Steven J. PHILLIPS, Ellicott City, MD (US); Oleksiy P. SERGYEYENKO, Baldwin, MD (US)

(21) Appl. No.: 15/901,622

(22) Filed: Feb. 21, 2018

Related U.S. Application Data
(60) Provisional application No. 62/461,274, filed on Feb. 21, 2017.

(51) Int. Cl. H01M 2/10

(52) U.S. Cl. CPC H01M 2/1055; B25F 5/00; H01M 2220/30

(57) ABSTRACT

The present disclosure is directed to a battery pack having a plurality of battery cells, a housing having a generally cylindrical shape having a top wall, a bottom wall and a side wall and having a height, a radius and a circumference and a central axis A perpendicular to the radius, a round central pin connector at a center of the top wall about the central axis A providing an attachment that allows for orienting an accessory about the central axis A, and a threaded adapter at a center of the bottom wall about the central axis A for connecting a variety of non-powered support attachments.

### RELATED APPLICATIONS

This application claims priority under 35 U.S.C. § 119(e) to U.S. Provisional Patent Application No. 62/461,274, filed Feb. 21, 2017, titled “Cylindrical Battery Pack and Power Tool System.”

### TECHNICAL FIELD

This application relates to a cylindrical battery pack and power tool system. In one implementation, the system includes a cylindrical battery pack and at least one powered tool/accessory that may be coupled to the battery pack.

### BACKGROUND

Various types of electric power tools are commonly used in construction, home improvement, outdoor, and do-it-yourself projects. Conventional power tools generally fall into two categories—corded power tools that are powered by an AC power source, e.g., an AC mains line, and cordless power tools that are powered by one or more DC power sources, e.g., a rechargeable battery pack.

Cordless power tools generally are used for lighter duty applications that require low or medium power and/or short runtimes, such as light duty sawing, light duty drilling, and fastening. As cordless tools tend to be more limited in their power and/or runtime, they have not generally been accepted by the industry for all applications. They are also limited by weight since the higher capacity batteries tend to have greater weight, creating an ergonomic disadvantage.

### SUMMARY

The present disclosure is directed to a battery pack having a plurality of battery cells, a housing having a generally cylindrical shape having a top wall, a bottom wall and a side wall and having a height, a radius and a circumference and a central axis A perpendicular to the radius, a round central pin connector at a center of the top wall about the central axis A providing an attachment that allows for orienting an accessory about the central axis A, and a threaded adapter at a center of the bottom wall about the central axis A for connecting a variety of non-powered support attachments.

These and other advantages and features will be apparent from the description and the drawings.

### BRIEF DESCRIPTION OF THE DRAWINGS

FIGS. 1A and 1B are perspective views of an exemplary embodiment of a battery pack of the present disclosure.

FIG. 2 is an exploded elevation view of the battery pack of FIG. 1.

FIGS. 3A and 3B are perspective views of the battery pack of FIG. 1 having a housing of the battery pack illustrated in a translucent manner to illustrate internal components of the battery pack.

FIG. 4 is a perspective view of the battery pack of FIG. 1 and an exemplary accessory of the instant disclosure prior to coupling.

FIG. 5A is a section view of the accessory and battery pack of FIG. 4 prior to coupling along a central axis and FIG. 5B is a section view of the accessory and battery pack of FIG. 4 after coupling along the central axis.

FIG. 6A is a perspective view of the accessory and battery pack of FIG. 4 after coupling and FIG. 6B is a perspective view of the accessory and battery pack of FIG. 4 after coupling illustrated a side wall of the accessory in a translucent manner.

FIG. 7 is a perspective view of the battery pack of FIG. 1 and an exemplary support attachment prior to coupling.

FIG. 8 is a perspective view of the support attachment of FIG. 7 from below.

FIG. 9 is an elevation view of another exemplary support attachment.

FIG. 10 an elevation view of an exemplary battery pack, accessory and attachment.

FIG. 11 is a perspective view of another exemplary battery pack of the present disclosure.

FIG. 12 is a perspective view of an exemplary accessory of the present disclosure.

FIG. 13 is another view of the battery pack of FIG. 11.

FIG. 14 is another perspective view of the accessory of FIG. 4.

FIG. 15 is a perspective view of another exemplary accessory of the present disclosure.

FIG. 16 is a perspective view of another exemplary accessory of the present disclosure.

FIG. 17 is a perspective view of another exemplary accessory of the present disclosure.

FIG. 18 is a perspective view of another exemplary accessory of the present disclosure.

FIG. 19 is a perspective view of another exemplary accessory of the present disclosure.

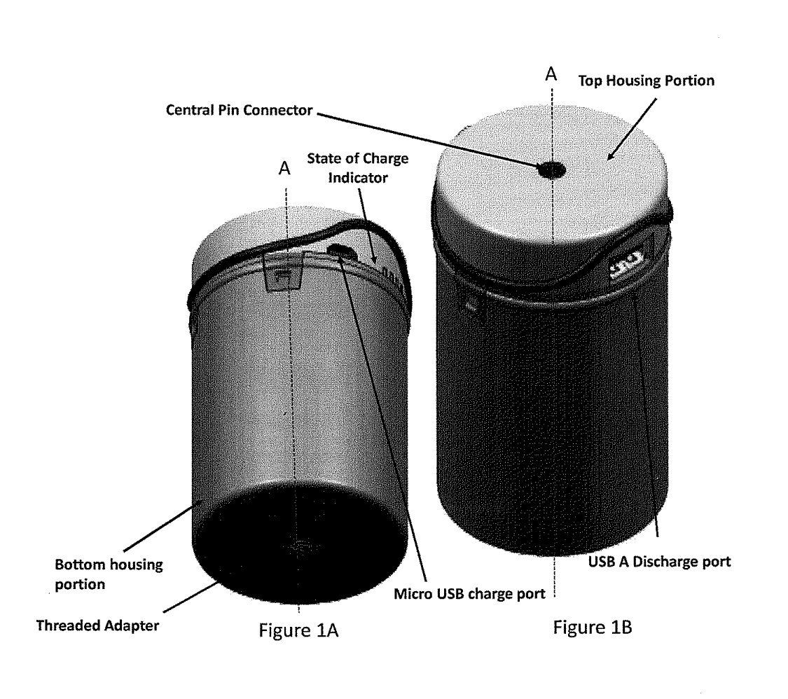

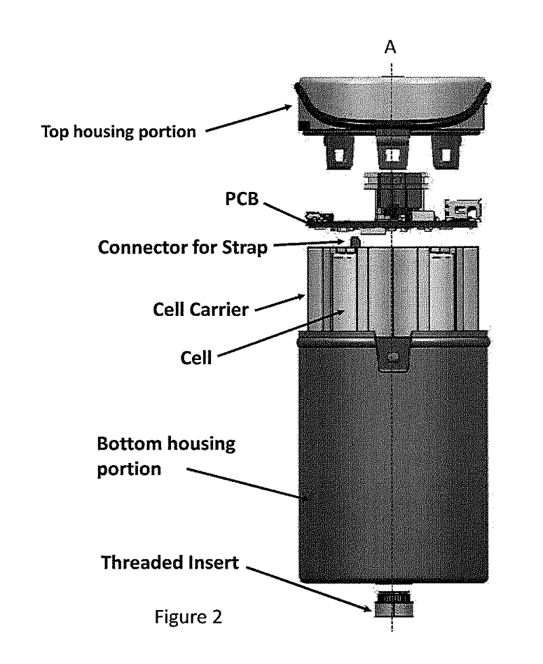

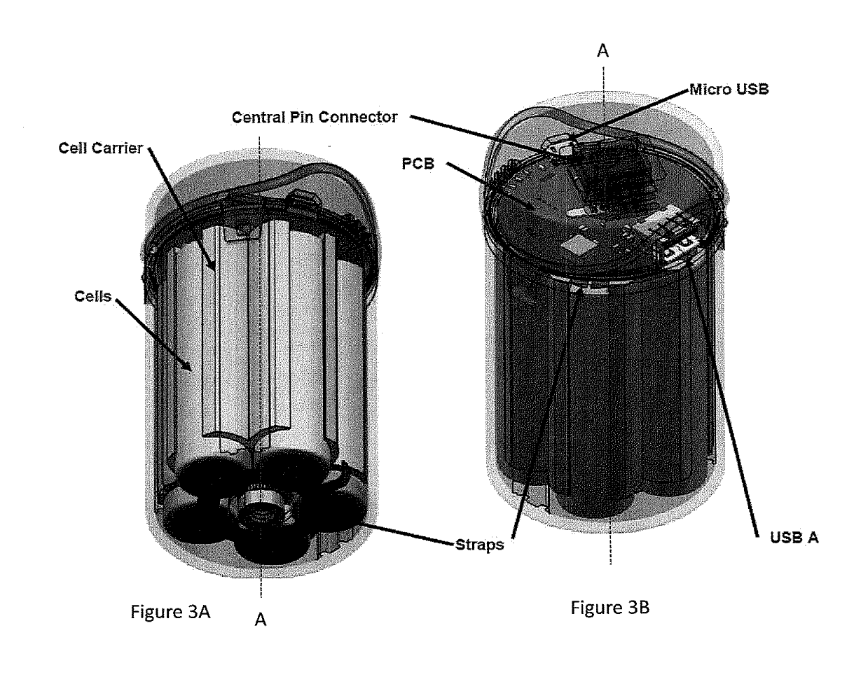

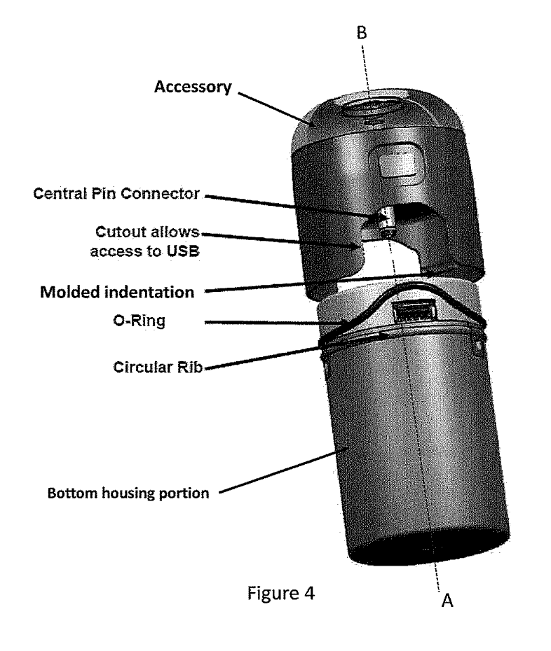

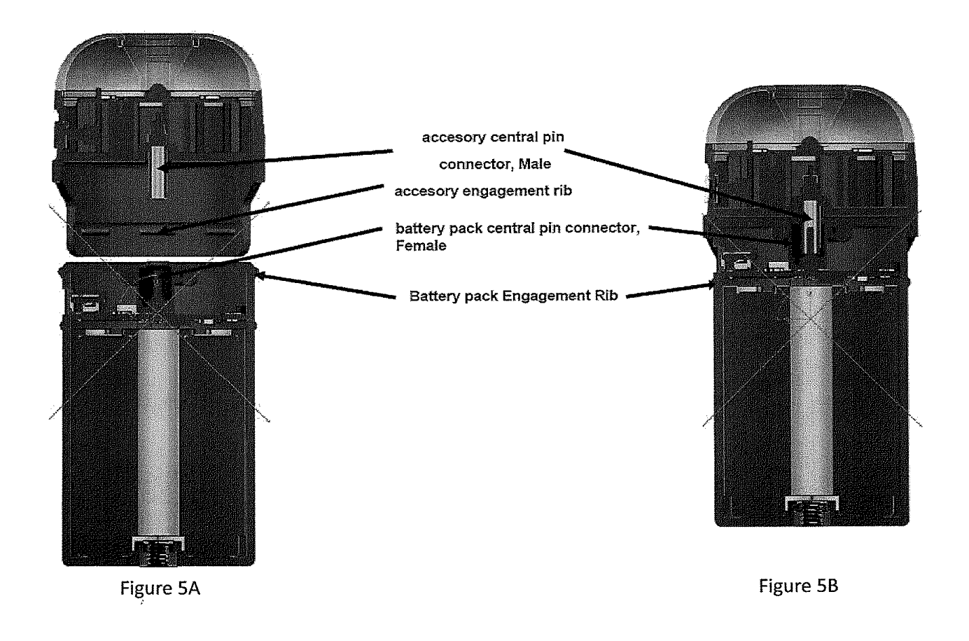

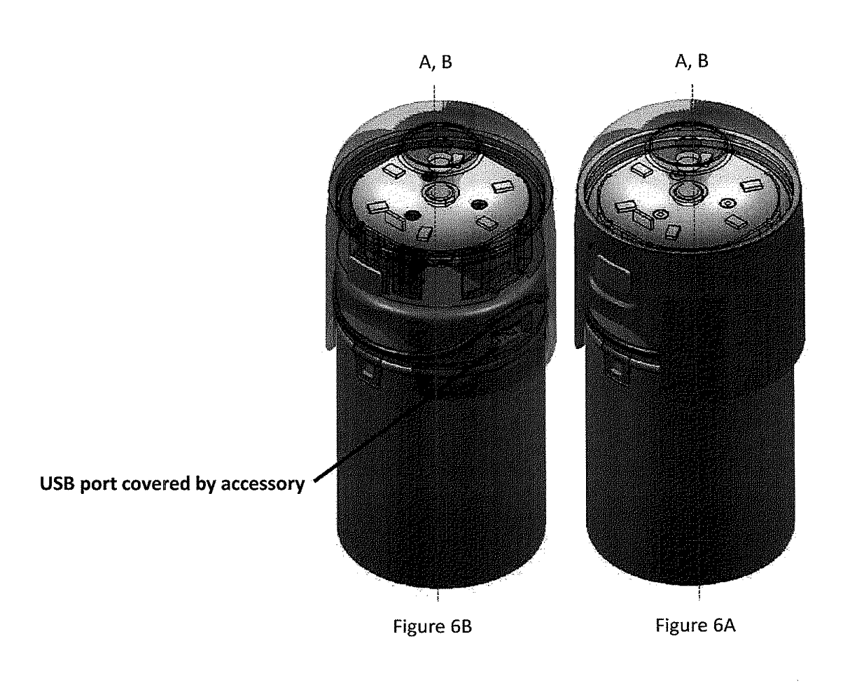

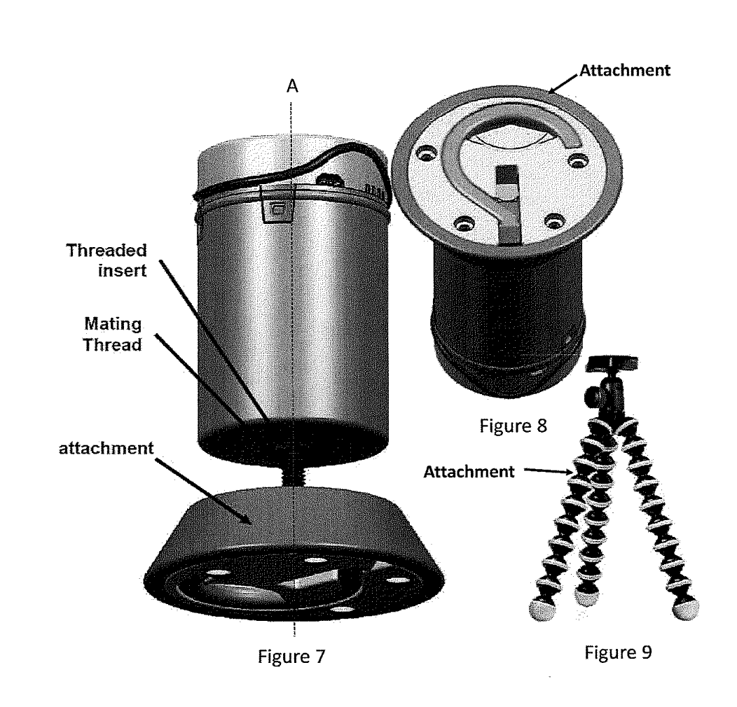

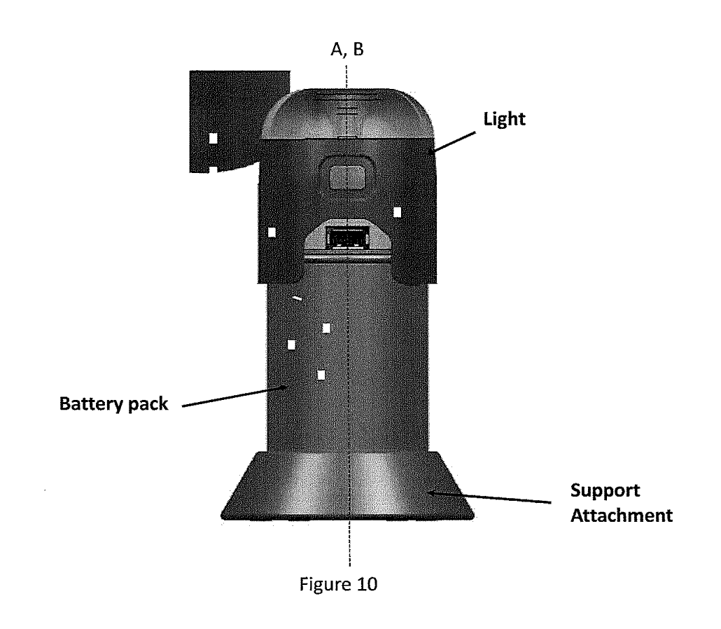

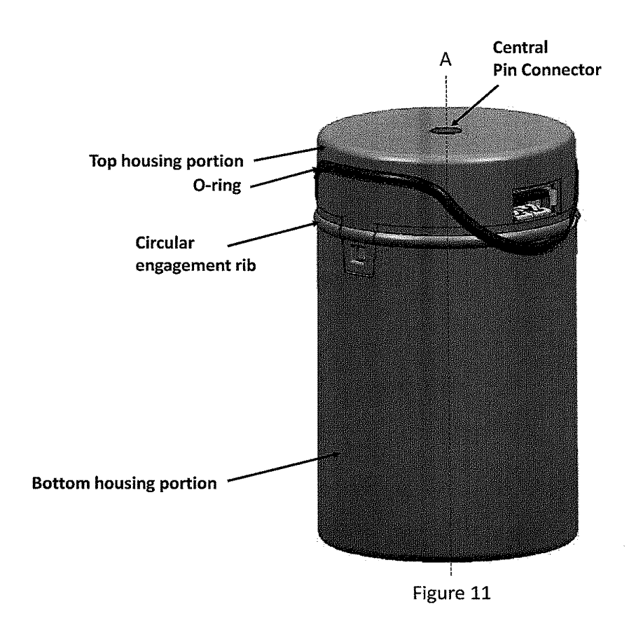

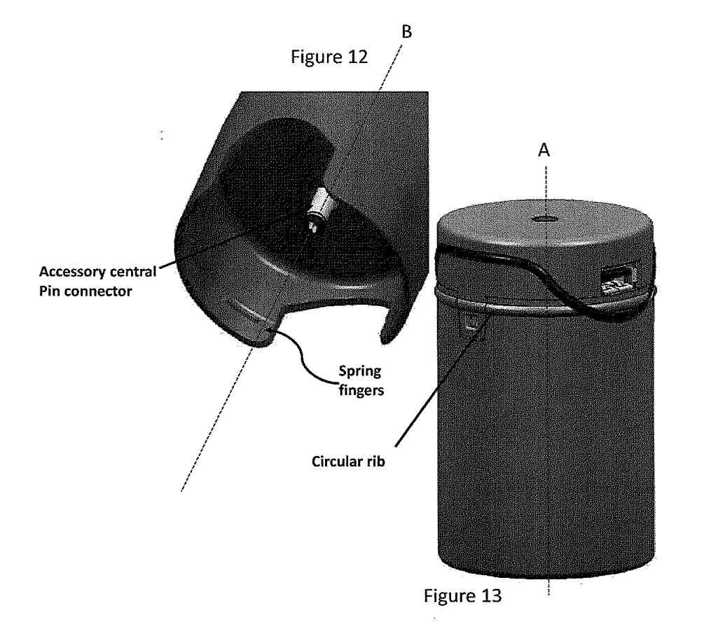

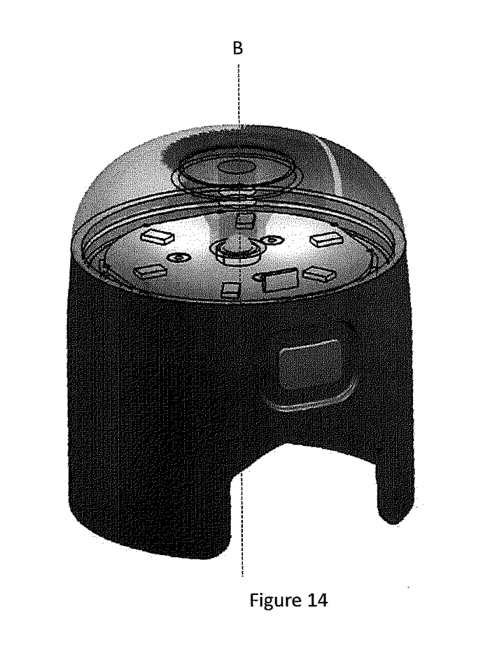

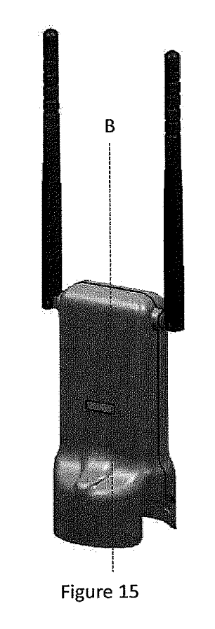

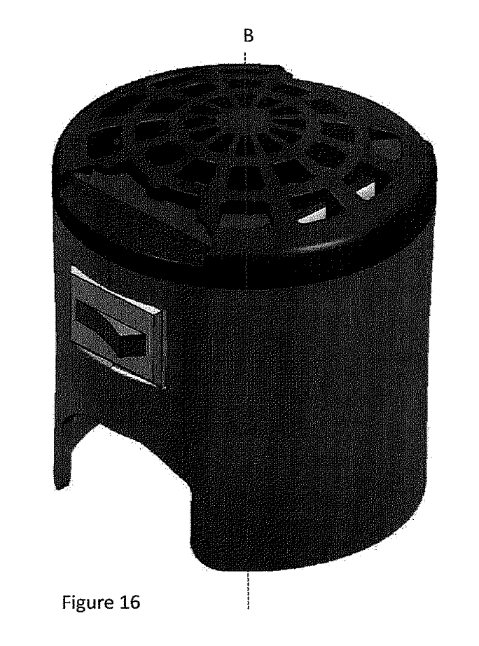

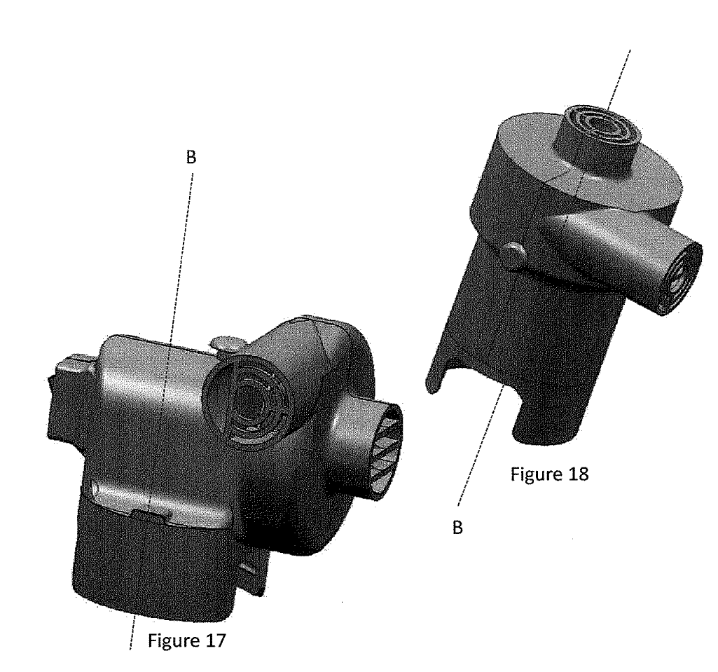

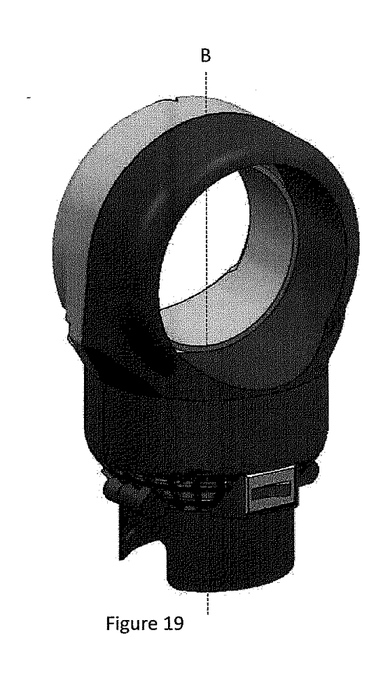

### DETAILED DESCRIPTION

A battery pack comprising five (5) 4 volt battery cells connected in parallel (1S 5P). The pack preferably uses energy cells rather than power cells for a high amp-hour rating.

The battery pack comprises a housing. The housing has a generally cylindrical shape having a top wall, a bottom wall and a side wall and having a height, a radius and a circumference. The housing comprises a top housing portion and a bottom housing portion coupleable to each other. The housing includes a central axis A perpendicular to the radius.

A round central pin connector is positioned at a center of the top housing portion of the battery pack housing about the central axis A. The connector provides an attachment that allows for orienting an accessory about the central axis A.

A micro-USB charging port is positioned at a first location on the circumference of the battery pack, a state of charge indicator is positioned at a second location on the circumference of the battery pack and a USB-A discharging port is positioned at a third location on the circumference of the battery pack.

A threaded adapter is included on the bottom wall of the bottom housing portion about the central axis A for connecting a variety of non-powered support attachments.

Internal Arrangement

The corepack includes five cells arranged in a circle. A cell carrier holds the cells in a fixed arrangement relative to each other and the housing. The carrier assists to weld a battery strap to the cells. A top battery strap is soldered directly to a printed circuit board (PCB) and a lower battery strap is connected via a wire lead (not shown) to the PCB. A two-part housing/case clips together to seal the PCB and the cells therein.

Battery Pack-Tool/Accessory Interface

The round central pin connector on the central axis A allows for accessories to be attached to the battery pack about the central axis A and then rotated about the central axis A to expose or cover the USB ports on the battery pack.

An O-ring seals the connection between the accessory and the battery pack, preventing water from contacting the central pin connector.

The accessory includes a living hinge that flexes to allow a molded convex indentation extending into an inner surface of the accessory to engage with a circular rib on the outer circumference of the battery pack.

By rotating the accessory it is possible to cover the USB ports thereby shielding them from rain, dirt and other debris.

Unpowered Bottom Attachment

A ¼-20 threaded insert on the bottom of the battery pack allows for a non-powered attachment to be screwed into the battery pack. A ¼-20 is a standard size for tripods and other (camera) attachments.

Powered Accessories

The battery system may accommodate many different powered attachments/accessories including but not limited to: lighting accessories, e.g., area lights, flash lights, and accent lights; environment accessories, e.g., fans (bladeless and bladed), bug repellant/diffuser, and resistive heating (blankets, hand warmers); electronic accessories, e.g., WiFi range extenders, Bluetooth speakers, and USB charging hubs; and outdoor tools, e.g., inflators.

Battery-Accessory Interface

The battery pack may include two (2) power outputs for accessories: a standard USB port and a centrally mounted pin connector (20 watts, roughly 2× power output of the USB port).

The accessory is physically coupled to the battery pack by two features: an electrical contacts spring inside the top pin connector and a cylindrical rib on an exterior surface of the battery pack couples with spring fingers on the accessory.

The accessory can be rotated about the central axis A to seal the USB ports on the battery pack or rotated to expose the USB ports.

The light accessory may include two modes: a spot/flashlight mode that uses a large central LED with a reflector cone and an area light mode that uses a ring of smaller LEDs and a translucent globe to produce diffuse lighting.

The WiFi range extender may be placed at the edge of a home or a WiFi coverage zone of an event to repeat a signal over a larger area. For example, the extender may be placed on a patio in a backyard to amplify the signal over the entire yard. Setup may be through a web-based interface that may be accessed from any WiFi-enabled device. The extender may remember previously established settings even after being disconnected from the battery pack.

The bug repellant/diffuser uses a resistive heating element to heat a pre-soaked pad that releases a bug repellant vapor. The diffuser may be compatible with Theracell® pads that use butane to heat the pads. The diffuser will heat twice as fast as conventional diffusers and does not require butane refills.

A low-pressure inflator for air mattresses, pool toys, and other inflatables. The inflator may have a vertical or a horizontal configuration.

A computer driven fan pointed vertically in a base to move air over an airfoil and create an airflow without a visible, spinning blade.

Numerous modifications may be made to the exemplary implementations described above. These and other implementations are within the scope of this application.

1. A battery pack comprising:
a plurality of battery cells;
a housing having a generally cylindrical shape having a top wall, a bottom wall and a side wall and having a height, a radius and a circumference and a central axis A perpendicular to the radius;
a round central pin connector at a center of the top wall about the central axis A providing an attachment that allows for orienting an accessory about the central axis A; and
a threaded adapter at a center of the bottom wall about the central axis A for connecting a variety of non-powered support attachments.
